(19) United States
(12) Patent Application Publication
(10) Pub. No.: US 2026/0245571 A1
(43) Pub. Date: Aug. 20, 2026

(54) RAPID AND ADAPTIVE DE-REVERBERATION METHODS, DEVICES AND SYSTEMS

(71) Applicant: Cypress Semiconductor Corporation, San Jose, CA (US)

(72) Inventors: Andrii TSEMKO, Melitopol (UA); Oleg KAPSHII, LVIV (UA); Ashutosh PANDEY, Irvine, CA (US); Ted WADA, Irvine, CA (US)

(73) Assignee: Cypress Semiconductor Corporation, San Jose, CA (US)

(21) Appl. No.: 19/059,244

(22) Filed: Feb. 20, 2025

(51) Int. Cl. G10L 21/0208

(52) U.S. Cl. CPC G10L 21/0208; G10L 2021/02082

(57) ABSTRACT

A method can include, by operation of an integrated circuit (IC) device, receiving and storing digital samples of an input audio signal taken over consecutive time periods, converting each digital sample into a sample frame comprising magnitudes of a plurality of frequencies of the digital sample at different frame sample points, periodically generating AC data sets from different consecutive sample frames, periodically determining new filter coefficients from at least the AC data sets, filtering an initial set of consecutive sample frames with default filter coefficients, filtering sets of consecutive sample frames that follow the initial set with at least new filter coefficients to generate filtered frames, and converting each filtered frames to a time domain output signal. A time domain output signal can be a de-reverberated version of the input audio signal. Corresponding devices and systems are also disclosed.

### TECHNICAL FIELD

The present disclosure relates generally to systems for de-reverberating audio signals, and more particularly to systems for de-reverberating voice signals where processing can rapidly begin and is capable of adapting to changing conditions.

### BACKGROUND

Reverberation of audio signals results from sound reflections in an environment that causes distortion. Such distortion can reduce quality, particularly the intelligibility of speech. Reverberated speech can adversely affect speech applications, such as wake-word-detection (WWD) and automated-speech-recognition (ASR).

FIG. 19 shows a conventional system 1901 for addressing reverberation in a voice signal. System 1901 can process relatively large blocks of audio data using a linear predictive inverse modulation transfer function (LP IMTF). In general, distorted voice data can be received and then analyzed to determine signal characteristics and filter parameters 1905. Distorted voice data can then be subject to a LP IMTF filtering operation 1913. Reverberation can be modeled as a modulation transfer function (MTF) that introduces reverberation. An LP IMTF operation can effectively provide the inverse, removing reverberation. Such an operation is linear predictive as it can be based on a linear model relating frequency components at one time, to frequency components at previous times.

In more detail, in a system 1901, voice distorted by reverberation can be recorded 1903. It is understood that recording voice data 1903 can include accumulating multiple samples (e.g., frames) into an overall larger block of voice data. The analysis 1905 includes a short time Fourier transfer operation 1907-0 to spectral components (e.g., magnitude and phase) over consecutive time periods. Autocorrelation (AC) coefficients for the spectral components can be calculated 1909-0. Filter coefficients 1911-0 can be calculated from the AC coefficients 1909-0.

Operations corresponding to those performed on distorted voice data can have been performed on ideal voice data (i.e., STFT 1907-1, AC coefficients 1909-1, and filter coefficient generation 1911-1) and resulting filter coefficients saved in memory 1917. The filter coefficients from the ideal sample and those derived from the distorted voice sample can be applied to the frequency component transforms of the distorted voice in an IMTF operation 1915. Filtered results can be transformed from the frequency domain back to the time domain as recovery (i.e., de-reverberated) voice data 1921.

While a system like that of FIG. 19 can provide de-reverberated distortion, the processing of an entire block of voice data can require a large amount of resources (e.g., memory, computing power) for applications that need a low latency response, such as WWD and ASR. Further, such a conventional approach may not be capable of adapting rapidly to changing conditions. System 1901 can be considered an “offline” mode type of system, as entire blocks are received, processed with relatively powerful computing resources, and then results of such processing returned.

FIG. 20 is a flow diagram of another conventional approach to de-reverberating speech. FIG. 20 is a flow diagram showing a conventional weighted prediction error (WPE) method 2001. A method 2001 uses iterations to model a reverberation component, and then subtracts such a component from an input voice signal. Distorted (e.g., reverberated) speech can be buffered (Y_buffer) and serve as initial observed voice data (Y_observed). The observed voice data can be modified by a gain value, and subtracted from the buffered value (Y_buffer-G*Y_observed). The result can be a new observed voice value (Y_observed(new)). The determination of gain and subtraction of a previous observed voice data can be iterated to arrive at a filter aimed at canceling reverberation. Following the iterations, a resulting new observed value (Y_observed(new)) can be stored in an output buffer (X_buffer), as a recovery (i.e., de-reverberated) value.

FIG. 21 is a flow diagram of another conventional system 2101 for de-reverberating speech that can use a neural network. A system 2101 can convert distorted speech into the frequency domain by STFT. A neural network can be a U-net type fully convolutional network, with two-dimensional (2D) convolution layers (CONV2D) having direct and skip connections. U-net can operate on 2D speech data composed of frequency versus time values. Results of the U-net network can be converted back to time domain voice values by an inverse STFT (ISTFT) to generate recovery speech. U-net network can be trained with reverberated speed samples and their corresponding clean (i.e., undistorted) counterparts. Once trained, the system 2101 can generate recovery speech values from distorted input speech values.

Conventional methods and systems like those shown in FIGS. 20 and 21 can process incoming frames of speech data, rather than entire blocks, like that of FIG. 19, and so provide a faster response time. Thus, the conventional cases of FIGS. 20 and 21 can be implemented as “online” mode type systems, and process speech samples as they are received. However, such conventional approaches can be complex and/or require specialized hardware and/or specialized hardware configurations, making them unsuitable for lower power, lower cost, portable applications.

It would be desirable to arrive at some way of providing fast, effective speech dereverberation that does not incur the computation and complexity penalty present in conventional approaches.

### SUMMARY

A method can include, by operation of an integrated circuit (IC) device, receiving and storing digital samples of an input audio signal taken over consecutive time periods, converting each digital sample into a sample frame comprising magnitudes of a plurality of frequencies of the digital sample at different frame sample points, periodically generating AC data sets from different consecutive sample frames, periodically determining new filter coefficients from at least the AC data sets, filtering an initial set of consecutive sample frames with default filter coefficients, filtering sets of consecutive sample frames that follow the initial set with at least new filter coefficients to generate filtered frames, and converting each filtered frames to a time domain output signal. A time domain output signal can be a de-reverberated version of the input audio signal.

### BRIEF DESCRIPTION OF DRAWINGS

FIG. 1 is a block diagram of a system and method according to an embodiment.

FIG. 2 is a block diagram of a system and method according to another embodiment.

FIG. 3 is a block diagram of a system and method according to a further embodiment.

FIG. 4 is a block diagram of a system and method according to another embodiment.

FIG. 5 is a block diagram of a system and method according to another embodiment.

FIG. 6 is a diagram showing the periodic calculation of autocorrelation (AC) values and de-reverberation (DR) filter values according to an embodiment.

FIG. 7-0 is a diagram showing the smoothing of filter values according to an embodiment. FIG. 7-1 is a diagram showing the smoothing of filter coefficients according to another embodiment.

FIG. 8 is a diagram showing a moving processing window according to an embodiment.

FIG. 9 is a block diagram showing a system and method for calculating AC values according to an embodiment.

FIG. 10-0 is a diagram showing the periodic generation of DR filter coefficients according to an embodiment. FIG. 10-1 is a diagram showing the generation of periodic autoregression (AR) coefficients according to an embodiment.

FIGS. 11-0 and 11-1 are block diagrams of a method and system of generating filter coefficients according to an embodiment.

FIG. 12 is a diagram showing the application of filter coefficients to a sample frame according to an embodiment.

FIG. 13 is a block diagram of a system according to an embodiment.

FIG. 14 is a diagram of an integrated circuit device according to an embodiment.

FIG. 15 is a block diagram of a system according to another embodiment.

FIG. 16 is a flow diagram of a method according to an embodiment.

FIGS. 17 and 18 show a flow diagram of a method according to another embodiment.

FIG. 19 is a block diagram showing a conventional off-line de-reverberation (DR) system.

FIG. 20 is a block diagram of a conventional on-line DR system.

FIG. 21 is a block diagram of another conventional on-line DR system.

### DETAILED DESCRIPTION

According to embodiments, speech data can be sampled and converted into frequency domain sample frames. Sample frames can initially be filtered by default filter values to remove or reduce reverberation. However, as sample frames are received, they can also be correlated in time, with respect to frequency, to generate correlation data sets. Correlation data sets can be used to derive filter values that can predict a most recent correlation values from previous correlation values. As filter values are generated, they can be applied to sample frames. After being filtered, sample frames can be deconverted to time domain values, corresponding to a de-reverberated audio signal. In this way, following filtering with initial filter values, filter values can be continually updated and applied to sample frames based on the temporal correlation to previous sample frames.

In some embodiments, sample frame filtering can correspond to an inverse transfer function filter that uses generated filter values in combination with “clean” filter values. Clean filter values can be derived from sample frames with no, or essentially no reverberation (e.g., undistorted voice data).

In some embodiments, transition from one filter to a previous filter can be smoothed. In some embodiments, filter smoothing can include averaging a newly generated filter values, with a previous filter value.

In some embodiments, correlation of sample frame frequency components can include an autocorrelation (AC) along frequency magnitudes.

In some embodiments, the generation of correlation data sets can include modifying by a forget factor, that can reduce the effect of past correlation values on a current correlation data set.

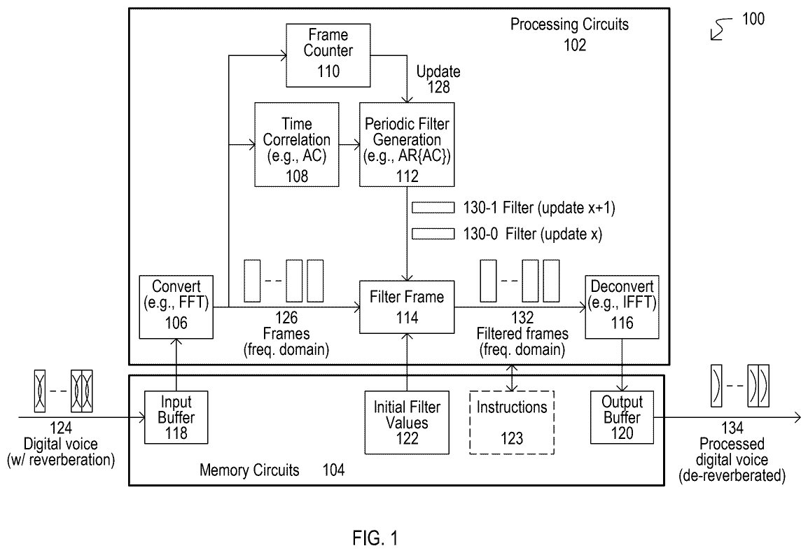

FIG. 1 is a block diagram of a system 100 according to an embodiment. A system 100 can include processing circuits 102 and memory circuits 104. Processing circuits 102 can include a convert section 106, a time correlation section 108, a frame counter 110, a filter generation section 112, a frame filter section 114, and a deconvert section 116. A convert section 106 can convert time domain samples of an audio signal into frequency domain values to generate sample frames 126. Such an action can include any suitable conversion calculation, including Fourier transforms, including but not limited to the short time Fourier transform (STFT). In some embodiments, a convert section 106 can generate a sample frame for each received audio sample. Sample frames 126 can include magnitudes for a range of frequencies suitable to a signal being processed. In some embodiments, audio samples can include voice data, and sample frames 126 can include magnitude values for frequencies having a range from about 1 Hz to 6000 Hz. However, such a range of frequencies should not be construed as limiting.

A time correlation section 108 can generate correlation data sets that can correlate sample frames to one another with respect to time. In some embodiments, time correlation section 108 can execute an AC computation on frequency magnitudes of a sample frame, with like frequency magnitudes of previous sample frames (i.e., frequency to frequency correlation) for fast, relatively low resource computation. However, alternate embodiments can include correlation between different frequency components (e.g., correlating one frequency component with one or more adjacent frequency components).

A frame counter section 110 can track the number of sample frames as they are generated, and in response, generate an update indication 128. A frame counter section 110 can include more than one frame count values at which to generate a update indication 128. That is, embodiments encompass update indications 128 at regular sample frame intervals, irregular sample frame intervals, and combinations thereof.

A filter generation section 112 can generate filters from AC data sets in response to an update indication 128. This can include calculating filter values that can predict one correlated data set from previous correlated data sets. In some embodiments, filter values can be linear predictive values derived from an autoregression (AR) calculation executed on an AC data set. Filter generation section 112 can periodically update filter values as sample frames are received and new AC data sets computed.

A frame filter section 114 can filter received sample frames using frame values. When sample frames are first generated, such filtering can use initial filter values 122, to enable enough sample frames to be accumulated to calculate an AC set sufficient to derive updated filter values (130-0/1). Sample frames can then be filtered using updated filter values (130-0/1). A deconvert section 116 can convert filtered sample frames into time domain values. Such an action can include any suitable conversion calculation, including an inverse Fourier transform corresponding to a Fourier transform of convert section 106.

Processing circuits 102 can include any suitable circuits for executing the operations as described herein, including but not limited to, one or more processors executing instructions, custom logic, programmable logic, and combinations thereof.

Memory circuits 104 can include an input buffer 118, an output buffer 120 and can store initial filter values 122. An input buffer 118 can receive and store digital voice data samples 124, such as voice samples that can be distorted from reverberation or the like. Input buffer 118 can be accessed by processing circuits 102 to process digital voice data sample 124 into sample frames 126. Processing circuits 102 can write deconverted sample frames to output buffer 120 as processed (e.g., de-reverberated) digital voice data 134. Such processed digital voice data 134 can be converted into analog form and/or processed in digital form for other purposes, including but not limited to wake word detection (WWD) or automatic speech recognition (ASR). Initial filter values 122 can be values calculated to correspond to a generic speaker, a targeted speaker, or combinations thereof. In some embodiments, initial filter values 122 can evolve over time, being generated by and/or modified according to filter values calculated by processing circuits 102. In some embodiments, memory circuits 104 can store instructions 123 for execution by processing circuits 102 to perform any of the operations described, or equivalents.

Memory circuits 104 can take any suitable form, including volatile memory circuits, nonvolatile memory circuits, and combinations thereof. Some or all of such circuits can be single port and/or multi-port. In some embodiments, an input buffer can include relatively fast memory circuits, such as static random access memory (SRAM). In some embodiments, initial filter values can be stored in nonvolatile memory circuits (but may also be preloaded into volatile memory circuits).

In some embodiments, a system 100 can be a single device to provide rapid, adaptable de-reverberation operations for portable devices.

Having described the various portions of a system 100, operations of the system will now be described. Circuits included in, or separate from, system 100 can detect analog audio signals that can include speaking, sample such analog audio signals as digital voice data 124 (which can include reverberation). Such digital voice data 124 can be written to input buffer 118. As digital voice samples 124 are received, convert section 106 can convert them into sample frames 126. Each sample frame can be processed by frame filter section 114. Initially, frame filter section 114 can use initial filter values 122 to generate filtered frames 132. Deconvert section 116 can convert filtered frames 132 into processed time domain audio samples, which can be stored in output buffer 120.

Sample frames 126 can also be processed by time correlation section 108 to create a correlation data set relating values of a sample frame to previous sample frames. Frame counter 110 can determine a number of sample frames processed by time correlation section 108. When such a number is within a predetermined limit, an update indication 128 can be generated by frame counter 110 (and the predetermined limit for triggering the update indication 128 reset or altered). In response to update indication 128, filter generation section 112 can calculate an update filter value 130-0 using a correlation data set generated by time correlation section 108. Frame filter section 114 can then begin filtering sample frames using the update filter value 130-0. When a number of sample frames processed reaches a predetermined limit (which may be the same as, or different than the previous predetermined limit), another update indication 128 can be generated, and filter generation section 112 can generate another update filter value 130-1 from another correlation data set created by time correlation section 108. Filter updates can then continue as more sample frames are processed.

In this way, sequential voice data converted into the frequency domain can be processed by initial de-reverberation filters, and then by updated de-reverberation filters calculated from time correlation data sets of accumulated voice data samples. Updated de-reverberation filters can continue to be generated as voice data samples are received.

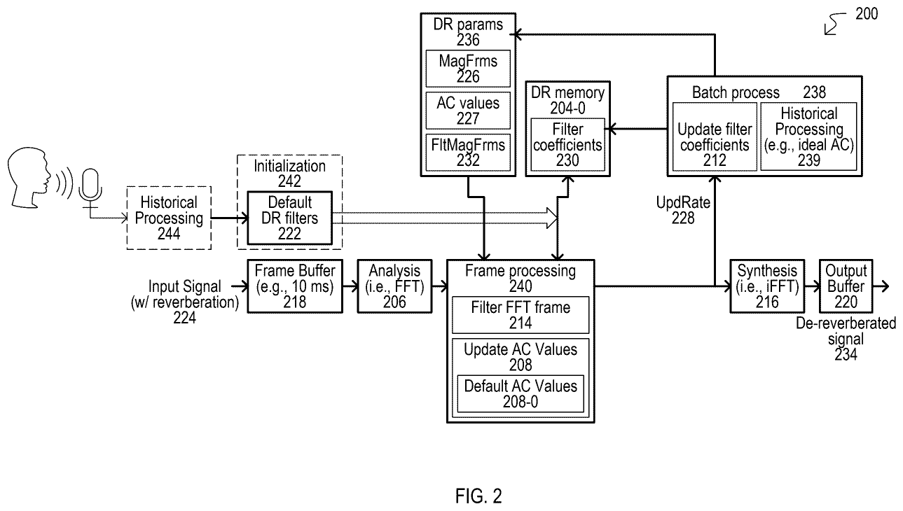

FIG. 2 is a block diagram of a system and method 200 according to another embodiment. In some embodiments, a system 200 can be one implementation of that shown in FIG. 1. A system 200 can include a frame buffer 218, default de-reverberation (DR) filters 222, an analysis section 206, a frame processing section 240, batch processing section 238, DR parameters 236, a DR memory 204-0, a synthesis section 216 and an output buffer 220. A frame buffer 218 can receive samples of an input signal 224 that may include distortion from reverberation. A frame buffer 218 can store samples of any suitable duration. In some embodiments, a frame buffer 218 can store samples of less than 20 milliseconds (ms), or not more than 10 ms. However, such particular sample durations should not be construed as limiting.

Analysis section 206 can convert samples, as they are received in frame buffer 218, into sample frames composed of frequency magnitudes. Such conversion can include a fast Fourier type transform (FFT). Resulting sample (FFT) frames can be received by frame processing section 240. In some embodiments such analysis can also yield phase values.

Frame processing section 240 can filter sample frames 214 and update AC values 208. Filtering frames 214 can include initially applying default DR filters 222 to sample frames, and then switching to updated filters according to an update rate 228 determined by frame processing 240. An update rate 228 can be a static value and/or a dynamic value. In some embodiments, and update rate 228 can be based on a number of received (or processed) sample frames. Updating AC values 208 can include calculating an AC data set based on received sample frames. An AC data set can correlate frequency magnitudes of sample frames to one another over time. In some embodiments, updating AC values 208 can start with a set of default AC values 208-0, which can then be updated in response to received sample frames. Default AC values 208-0 can be precalculated based on expected speech spectra. In addition or alternatively, default AC values 208-0 can be updated over time, based on previous voice processing operations. In some embodiments, updating AC values 208 can include correlating frequencies of a sample frame to the same frequencies of previous sample frames, which can be advantageously fast and require lower resources. However, alternate embodiments can include correlating magnitudes of multiple different frequencies to one another over time.

Batch processing section 238 can update filter coefficients 212 in response to a rate update indication (UpdRate) 228. Such an action can include the calculation of filter coefficients based on current real-time AC values (which can include reverberation) and “ideal” AC values corresponding to ideal speech. In some embodiments, such ideal AC values can be pre-calculated with historical processing 239. In some embodiments, such a calculation can be an AR calculation. Resulting filter coefficients can correspond to an inverse modulation transfer function (IMTF) that removes and/or substantially reduces the effects of reverberation.

DR parameters 236 can be values utilized by frame processing section 240 to process sample frames, and include, but are not limited to frame magnitudes (MagFrms) 226, AC values 227 and filtered frame magnitudes (FltMagFrms) 232. In some embodiments, MagFrms 226 can be an array of sample frame values, each corresponding to consecutive sample of an audio signal. In some embodiments, such values can be normalized. Similarly, FltMagFrms 232 can be an array of frame values that have been filtered by frame processing 240. In some embodiments, such values can also be normalized. AC values 227 can be an array of values as updated by frame processing 240. DR memory 204-0 can store filter coefficients 230 for use by frame processing 240 for filtering sample frames.

Synthesis section 216 can deconvert frames filtered by frame processing 240 into corresponding time domain values. Synthesized audio values can be stored in output buffer 220 and then accessed as a de-reverberated signal 234.

In some embodiments, a system 200 can include historical processing 244. Historical processing 244 can include a system 200 processing audio signals as the system operates to generate default filter values. In some embodiments, generating default filter values can include calculations that are the same, or similar to those used in batch process section 238 to update filter coefficients based on AC values 227. Accordingly, in an initialization operation 242 for a system, executed before audio sample processing, can load previously calculated and/or calculate default filter values 222.

A system 200 can provide frame-based processing flow that can be structured in a way that can start from a pre-calculated configuration (with default AC values 208-0 and default filter coefficients 222). Such default values can be tuned to some initial expected distortion level and/or evolve over time with historical processing 244. Default ideal AC values 239 can be pre-calculated and stored for use in generating filter signals that can evolve over time. This can allow signal processing to start with a first frame and adapt the processing if the signal distortions differ a lot from the pre-calculated values by ongoing collection of audio statistics. An “ideal” voice can be one that is close to typical audio from a system user. In some embodiments, distortion characteristics can be pre-trained per some middle level of distortions and can be learned after some time of a device usage.

In this way, de-reverberation processing of audio data of relatively small sample size can begin immediately using default IMTF filters values, and then transition to calculated IMTF filter values based on an autocorrelation of frequency components of a current sample frame and previous sample frames.

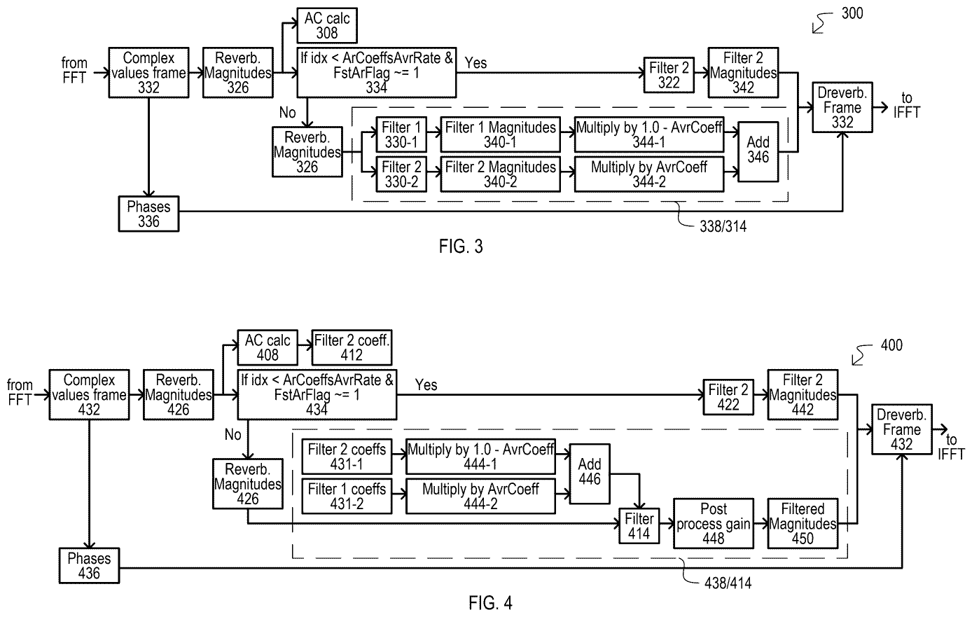

FIG. 3 is a diagram of a system and method 300 according to a further embodiment. A system/method 300 can process sampled audio data with two frames, a most recently calculated frame (Frame 2) and a previously calculated frame (Frame 1). A system 300 can receive a complex frame value 332, which can have been generated by a transform operation, including but not limited to short time Fourier transform (STFT). A complex frame value 332 can include frequency magnitudes 326 and phases 336. A system 300 can further include an AC calculation 308, determination of initial frames for processing 334, an initial frame filtering 322/342, and filter updating and filter smoothing 338/314.

An AC calculation 308 can take the form of any of those described herein or equivalents. Determination 334 can determine when a number of sample frames (idx) is less than an update rate (ArCoeffsAvrRate) and first filter flag (FstArFlag) is active. If such a determination is positive (Yes from 334), a filter 322 can be selected and its filter magnitudes 342 applied to sample frames with corresponding phase values 336 to generate de-reverberated (filtered) frames 332. In some embodiments, a filter 322 can be an initial (or default) filter as described herein and equivalents. If a determination is negative (No from 334), sufficient sample frames can have been processed to have calculated an updated filter (Filter 2, 330-2), and there can exist a previous filter (Filter 1, 330-1). A previous filter 330-1 can be default filter (following the first calculation of a new filter value), or a previously calculated filter value.

Frame filter smoothing 338/314 can smooth filtering by using a combination of Filters 2 (current filter) and Filter 1 (previous filter). In the embodiment shown, Filter 1 can be calculated or recalled 330-1. Magnitude components 340-1 for Filter 1 can then be determined 340-1. Filter 1 magnitudes 340-1 can be adjusted by a first smoothing value 344-1. In the embodiment shown, a first smoothing value can be one minus an average of filter coefficient values (1.0−AvrCoeff), and the adjustment is multiplication. While embodiments use an average value, any other suitable value that represents a group of filter coefficients is anticipated. Resulting Filter 1 smoothed coefficients can be applied to sample frames to generate first initial filtered frames.

Frame filter smoothing 338/314 can also include calculating a latest filter 2 value 330-2. Magnitude components 340-2 for filter 2 can then be determined 340-2. Filter 2 magnitudes 340-1 can be adjusted by a second smoothing value 344-2. In the embodiment shown, a second smoothing value can be AvrCoeff. Resulting Filter 2 smoothed coefficients can be applied to sample frames to generate second initial filtered frames. First and second initial filtered frames can be added together 346 to arrive at de-reverberated frames 332.

De-reverberated frames 332 can be subject to an IFFT operation to arrive at a de-reverberated audio signal.

FIG. 4 is a diagram of a system and method 400 according to another embodiment. A system/method 400 can include items like those of FIG. 3, and such like items are referred to by the same reference character but with the leading digit being a “4” instead of a “3”, including a complex frame value 432 with frequency magnitudes 426/phases 436, AC calculation 408, initial frames for processing 434, an initial frame filtering 422/442, filter update and smoothing 438/414, and de-reverberated frames 432. System/method 400 can differ from that of FIG. 3 in that filter smoothing 438/414 can be simplified and faster than that shown in FIG. 3. FIG. 4 shows Filter 2 coefficients being calculated 412 from AC values 408.

Referring still to FIG. 4, frame filter smoothing 438/414 can include adjusting Filter 2 coefficients by a first smoothing value 444-1. In the embodiment shown, a first smoothing value can be 1.0−AvrCoeff. Frame filter smoothing 438/414 can also include adjusting Filter 1 components by a second smoothing value 444-2. In the embodiment shown, a second smoothing value can be AvrCoeff. Resulting coefficients can be added together 446 and used to filter sample frames 414. Gain values can be applied to filtered frames 448 to filtered frames to create filtered magnitudes 450. Such filtered magnitudes 450 can be adjusted with phase data 426 to create de-reverberated frames 432.

The embodiments of FIGS. 3 and 4 can filter input FFT frames to remove/reduce reverberation. For a smooth change in the applied filters, input signal data can be adjusted using a new filter and previous filter (e.g., averaging) with weighting at an output. The system 400 of FIG. 4 presents an embodiment that can provide a faster processing than that of FIG. 3, by averaging filter coefficients and subsequently applying filtering after that. A system 400 can be tuned in an optimal way to balance adaptation speed (e.g., updates in filter values) and the amount of calculations needed for filters updates and transitions. That is, if more computation/memory resources are available, filter updates can occur more frequently, and vice versa. Further, in some embodiments, such tuning can be dynamic. If system resources are being taxed, filter updates can be less frequent, and vice versa.

In this way, a current DR filter value can be averaged with a previous DR filter value to smooth the filtering of sample frames.

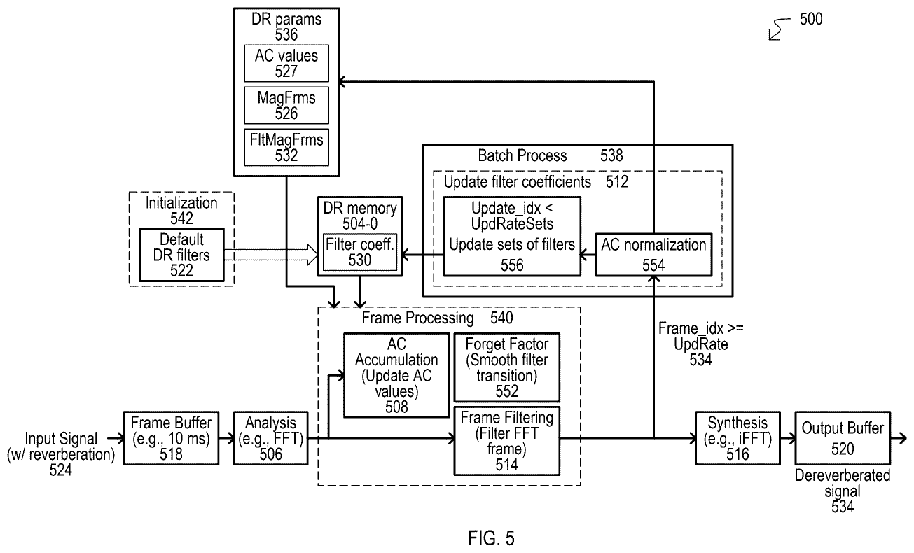

FIG. 5 is a block diagram showing a system and method 500 according to another embodiment. A system 500 can include items like those of FIG. 2, and such like items are referred to by the same reference characters but with the leading digit being a “5” instead of “2”.

Referring still to FIG. 5, frame processing 540 can include AC accumulation 508, frame filtering 514, and application of a forgetting factor 552. AC accumulation 508 can include generating a running matrix of AC values correlating sample frame frequency magnitudes to those of previous sample frames. Application of a forgetting factor 552 can reduce the effect of previous AC values on current AC values. In some embodiments, a forgetting factor can be a scalar value less than one. A forgetting factor 552 can be a fixed value, or can vary according to processing stage and/or processing results. Frame filtering 514 can filter sample frames using filter coefficients 530 and DR parameters 536.

A number of sample frames received (and filtered) can be tracked with a frame index value (Frame_idx). Frame_idx can be reset periodically, in response to predetermined events and/or a combination thereof. A value of Frame_idx can trigger a batch processing 538 which can update a set of filters being applied to sample frames (i.e., filters applied in 514). In the embodiment shown, when Frame_idx is greater than or equal to a limit UpdRate 534 a batch process can be initiated. A limit value UpdRate can be constant, or can vary. In some embodiments, a value UpdRate can be smaller as initial sample frames are processed, to enable filter values to more rapidly update from default filter values 522.

Batch processing 538 can receive accumulated AC values 508 as adjusted by forgetting factor 552. Batch processing 538 can include updating filter coefficients 512. In the embodiment shown, updating filter coefficients 512 can include normalizing a set of accumulated AC values (generated using a forgetting factor 552). Normalized AC values 554 can be provided to DR parameter section 536 as AC values 527.

Updating of filter coefficients 556 can vary according to a number of sample frames processed. A value UpdRate_idx can be a number of sample frames processed. In the embodiment shown, when UpdRate_idx is less than a limit UpdRateSets, filters can be updated in a way that can smooth transitions from a previous filter to a new updated filter. As but one example, a previous and updated filter can be combined. When UpdRate_idx is greater than or equal to limit UpdRateSets, such smoothing effects can be removed, and an applied filter can use the updated filter coefficients (i.e., previous filter coefficients are not used in filtering sample frames).

A system 500 like that of FIG. 5 can implement several steps to enable the rapid processing of audio signals as they are received (i.e., operate in an online mode). Such features can include an initial state configuration 542 to start processing frames without long latency that conventional systems can incur due to audio analysis at the start of processing. The generation and accumulation of an AC matrix 508 that is localized in time, along with application of a forgetting factor enable ongoing algorithm adaptation to an environment. Mechanisms for smooth transition between filtering characteristics 512 in time can reduce distortions that may occur from immediately switching from the application of one calculated de-reverberation filter to the next.

In this way, a system can provide initial default DR filter values followed by dynamically updated filter calculations, based on weighted in time autocorrelation of audio sample frequency components. Such initial rapid and evolving filtering can enable online de-reverberation without relatively large computing and/or memory resources.

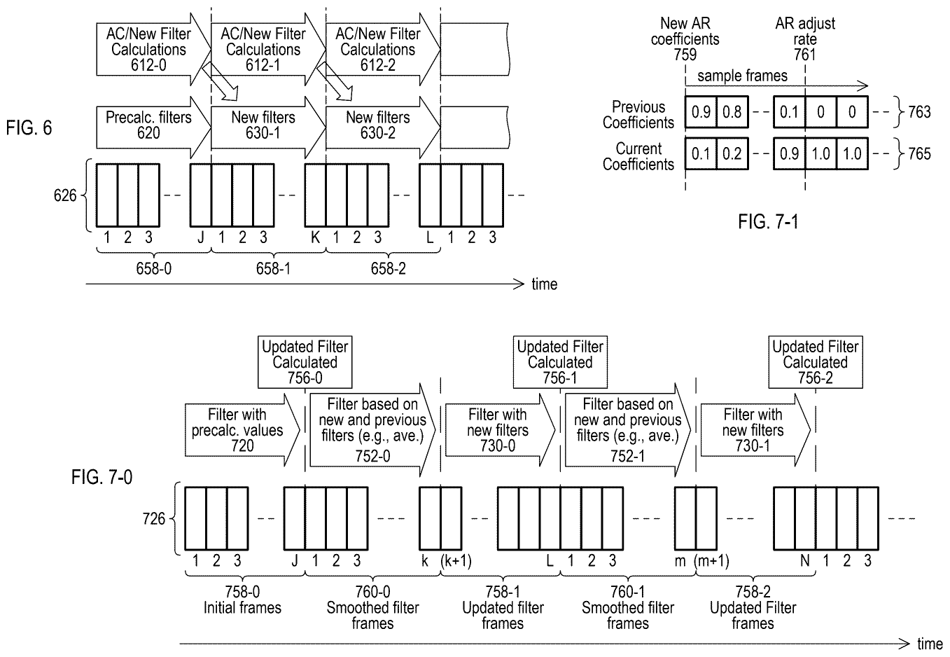

FIG. 6 is a diagram showing the processing of sample frames according to an embodiment. FIG. 6 shows sample frames 626 processed over time, which can be divided into sample frame sets 658-0 to 658-2. Processing of sample frames can begin with an initial set 658-0 of “J” sample frames. An initial set 656-0 of sample frames can be processed with precalculated (default) filter values 620. This can enable processing to start up receipt of a first sample frame. While the initial set 656-0 is processed with precalculated filter values 620, AC values can be accumulated until the number is sufficient to generate a first set of updated filter values 612-0.

A next set 656-1 of K sample frames can be processed with newly calculated filter values 630-1, which can have been calculated using an AC computation on initial set 658-0 sample frames. While sample frames of set 656-1 are processed with filter values 630-1, AC values can continue to be calculated and a second set of filter values 630-2 can be calculated. The process can then repeat, with newest filter value 630-2 being applied sample frames of set 658-2, while AC values and another set of filters are calculated 612-2.

In the embodiment shown, sample sets 658-0, 658-1 and 658-2 can include “J”, “K” and “L” sample frames, respectively. In some embodiments, J, K and L can be the same value. However, in other embodiments, J, K and L can differ from one another. In an embodiment, J can be less than K and L, to reduce a number of frames processed by default filter values. In another embodiment, J<K<L. In still other embodiments, K and L can be dynamically changed, with sample set sizes being reduced in response to greater variation between a new filter value and previous filter value and/or decreased correlation in consecutive sample frames.

In this way, received sample frames can be filtered essentially immediately with precalculated DR filter values. Subsequently, as sample frames are correlated with one another, updated filter values can be calculated based on such correlation. Such updated filter values can filter subsequently received sample frames.

FIG. 7-0 is a diagram showing the processing of sample frames according to another embodiment. FIG. 7 shows processing that can smooth transitions between filter changes. FIG. 7-0 shows sample frames 726 processed over time, which can be conceptualized as including an initial frame set 758-0, smoothed filter frame sets 760-1/2 and updated filter frame sets 758-1/2. In a manner like that of FIG. 6, an initial frame set 758-0 can be filtered with precalculated filter values 720. All or a portion of the sample frames of initial set 758-0 can be used to calculate updated filter values 756-0. Unlike FIG. 6, following the calculation of update filter values 756-0, a subsequent sample frame set 760-0 can be filtered with a combination of a new (i.e., updated) filter value and previous filter values 752-0 (e.g., an averaging, or changing the weighting of the two filter values). Thus, sample frames in smoothed filter frame set 760-0 can be filtered with filter values derived from precalculated filter values 720 and updated filter values 756-0. Following smoothed filter frame set 760-0, a following frame set 758-1 can be filtered with updated filter values 756-0 (without using precalculated filter values 720).

All or a portion of all previous sample frames can be used to calculate another set of updated filter values 756-1. Subsequently, the following sample frame set 760-1 can be filtered with a combination of the new filter values 756-1 and previous filter values 756-0. Following that, filtering can utilize the latest filter values (756-1), and not include previous filter values.

In this way, DR filtering of sample frames can start with precalculated filter values. Then, as update filter values are calculated, sample frames can be filtered with a combination of the new and previous filter values, such as by averaging or weighting such filter values.

According to some embodiments, filter coefficients or AR generated coefficients can be smoothed before being applied to sample frames. Upon generation of new filter/AR coefficients, coefficients actually applied to sample frames can be a mix of newly calculated and previous coefficients. In some embodiments, a proportion of new coefficients can be increased as a proportion of old coefficients is decreased.

FIG. 7-1 shows a smoothing of coefficients according to one embodiment. FIG. 7-1 shows a portion of previous coefficients 763 and a portion of current coefficients 765. Such coefficients can be values applied to sample frames or values included in the computation of applied filter coefficients. As shown, upon computing new coefficients 759, initially a larger portion (0.9) of the previous coefficients can be used with a smaller portion (0.1) of current coefficients. With each subsequent frame, or group of frames, the proportion can change with the amount of previous coefficients falling while the amount of current coefficients increases. Once a AR adjust rate is reached 761, previous coefficients may no longer be used, while all of new coefficients can be used.

In this way, the effect of calculated coefficients for DR filters can be smoothed, by applying a filter that includes an increasing proportion of newly calculated coefficients and a decreasing proportion of previously calculated filter coefficients.

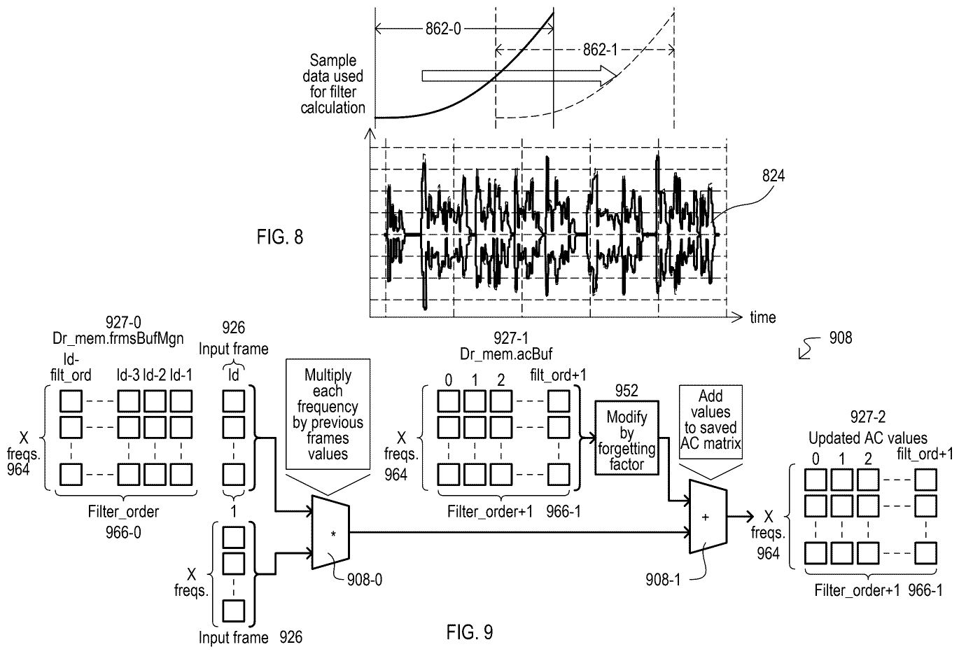

FIG. 8 is a diagram showing the processing of audio data according to an embodiment. FIG. 8 shows digital voice data 824 for processing, which can be composed of multiple samples of limited duration (e.g., less than 25 ms). Unlike conventional offline methods, processing for DR can begin with receipt of a first sample, rather than the entire block of voice data. As understood from the descriptions herein, initial samples can be processed with default/precalculated DR filter values. However, as more and more samples are accumulated over time, filter values can be updated based on such samples (e.g., based on AC of samples). As also described herein, time correlated data can be subject to a forgetting factor that lowers the weight of a sample frame the further it is in time. Accordingly, as shown in FIG. 8, some embodiments can be conceptualized as having a processing window that shifted in time, where the effects of older sample data have less effect on an applied filter value. FIG. 8 shows one processing window 862-0 with a curve reflecting the effect of sample frame on a resulting filter value. Processing window 862-1 shows how the window can be shifted in time.

In this way, embodiments can process audio data with DR filters based on samples over time, where the effect of each samples diminishes the further the sample is in time from a current sample.

FIG. 9 is a block diagram of an AC processing system 908 and method according to an embodiment. A system 908 can accumulate values for an AC matrix upon receipt of new sample frame, shown as an input frame 926, update the AC matrix. Input frame 926 can include values (e.g., magnitudes) for “X” frequencies 964, where X is an integer greater than one. Sample frames in FIG. 9 are labeled according to their order of receipt in time. So a newest sample frame is input frame 926 (Id). Values corresponding to a previous sample frame are shown as (Id-1, Id-2, etc.) and can form a previous sample frame matrix 927-0. In addition, previous sample frame matrix 927-0 can have a size (i.e., number of columns) related to a filter order (e.g., number of filter coefficients) “filter_order” 966-0.

Upon receipt of an input frame 926, system 908 can retrieve a previously previous sample frame matrix 927-0. Previous sample frame 927-0 can have been precalculated for initial sample frame processing, previously calculated from received sample frames, or a combination thereof. A frequency component of each previous sample frame value (column of 927-0 in the example shown) can be multiplied 908-0 by a corresponding frequency component of input frame 926, this can include input frame 926 being multiplied itself. Such a multiplication operation can result in a matrix having a size “filter_order+1” as it includes a new column corresponding to input frame 926.

A previous AC matrix 927-1 can be recalled from a storage location in a memory. Such a previous AC matrix 927-1 can have been precalculated for initial sample frame processing, previously calculated from received sample frames, or a combination thereof. Previous AC matrix 928-1 can have a size of at least filter_order +1 966-1. A system 908 can modify previous AC matrix 927-1 by a forgetting factor 952. Such an action can reduce the weight of AC values corresponding to previous sample frames. In some embodiments, such an operation can include multiplying by a scalar having a value less than one (e.g., 0.98 to 0.90). However, alternate embodiments can include any other suitable forgetting operation, including non-linear reduction in weight the further an AC value is in time. A resulting matrix (as modified by a forgetting factor) can be added to the matrix created by addition operation 908-0 to create an updated AC matrix 927-2 of size filter_order+1 966-1.

In this way, correlation values for frequency components of audio sample frames can be accumulated, subject to a forgetting factor, and then used to derive DR filter coefficients.

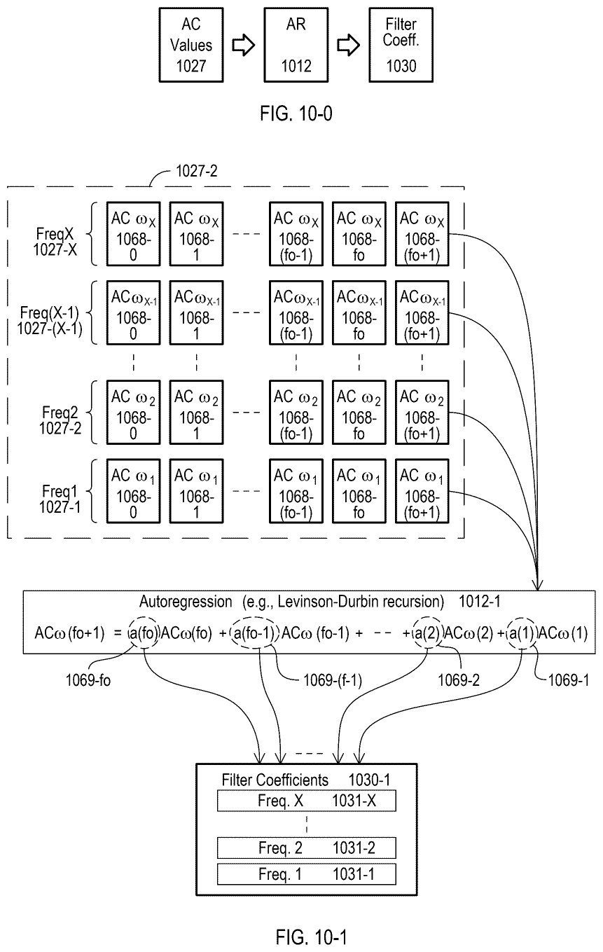

FIG. 10-0 is a diagram showing the generation of DR filter coefficients according to an embodiment. AC values 1027 can be periodically accumulated from sample frames of an audio signal, as described herein or equivalents. After a certain number of AC values have been accumulated, an autoregression calculation 1012 can be executed to derive coefficients of an AR model that can relate current sample frame frequency magnitudes, to previous sample frame magnitudes. Such coefficients can serve as, or be used to DR filter coefficients 1030 for application to a sample frame.

In this way, as autocorrelated frequency values are accumulated, periodic autoregression calculations can be executed to generate filter coefficients that can serve as, or be used to derive de-reverberation filter coefficients.

FIG. 10-1 is a diagram showing the generation of DR filter coefficients according to another embodiment. FIG. 10-1 shows a matrix of AC values 1027-2. A matrix of AC values 1027-2 can include rows 1027-1 to 1027-X and columns Each row can correspond to different frequency (1 to X). Each column can correspond to a different filter order (0 to fo+1), as well as a different temporal order, with 1068-(fo+1) being most recent, and 1068-0 being oldest. In some embodiments, AC values 1027-2 can be generated in the manner shown in FIG. 9. AC values of each row (1027-1 to 1027-X) can be subject to an autoregression (AR) calculation to generate coefficients 1069-fo, 1069-(fo−1) . . . 1069-1 for meeting the relationship shown. In some embodiments, such a calculation can be Levinson-Durbin recursion, however, embodiments anticipate any other suitable AR calculation. In some embodiments, AR calculations 1012-1 performed on each frequency row (1027-1 to 1027-X) (e.g., frequency bucket) to derive a set of coefficients (1031-1 to 1031-X) for such frequencies. In some embodiments, coefficients can correspond to an infinite impulse response (IIR) filter for an inverse modulation transfer function for de-reverberation.

In this way, autocorrelation values for different frequencies of a sample frame can be subject to an autoregression calculation to derive de-reverberation filter coefficients for each such frequency.

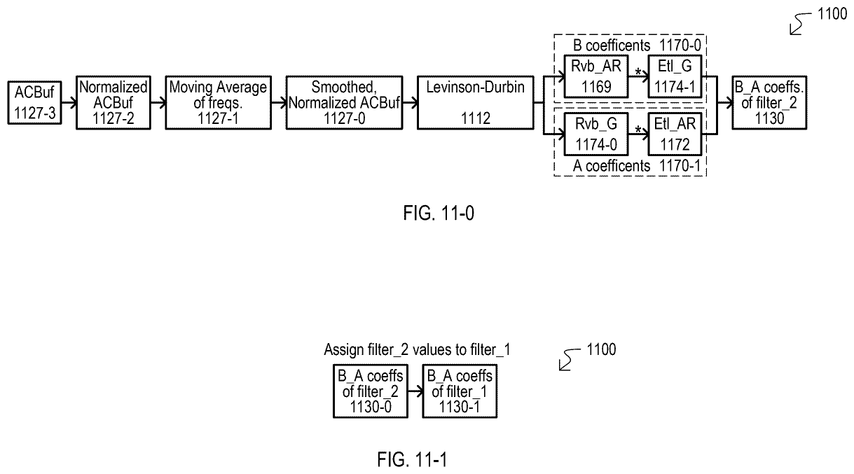

FIGS. 11-0 and 11-1 show a system 1100 and method for generating DR filter coefficients for application to a sample frame to remove de-reverberation. FIG. 11-0 shows the generation of DR filter coefficients that can combine values generated from sample frames and values from an ideal audio case. A system 1100 can begin with AC values that can be stored in an AC buffer 1127-3. Such AC values can be generated according to any of the embodiments herein and equivalents. In the embodiment shown, AC values can be normalized 1127-2. Such normalization can take any suitable form, including but not altering frequency values to a scale common to all processed AC values. In some embodiments, normalization can result in normalized AC values that range from +1 to −1.

Normalized AC values 1127-2 can be subject to a smoothing operation 1127-1, which can include any suitable processing that can reduce extreme variations in data values. In the embodiment shown, such an operation can include calculating a moving average on normalized AC values. A resulting smoothed AC data value set (e.g., matrix) can be stored in a buffer 1127-0.

Smoothed, normalized AC values can then be used to calculate filter coefficients that can predict AC values corresponding to one sample frame from AC values corresponding to previous sample frames 1112. In the embodiment shown, an AR calculation can be used, in particular, a Levinson-Durbin regression. An AR calculation 1112 can generate AR filter coefficients 1169 (Rvb_AR).

According to embodiments, two sets of applied filter coefficients can be calculated, B coefficients 1170-0 and A coefficients 1170-1. Such calculations can use coefficient values (Rvb_AR 1169, Etl_AR 1172) and gain values (Rvb_G 1174-0, Etl_G 1174-1). Coefficient value Rvb_AR 1169 can be derived from an AC data set as described. Coefficient values Etl_AR 1172 can correspond to an ideal or reference value (e.g., audio signal without reverberation), referred to herein as “etalon” values. In some embodiments, etalon coefficient values 1172 can be generated in a same, or similar fashion to those used to generate Rvb_AR 1169, but with sample frames of an reference (e.g., undistorted) audio signal. In some embodiments, gain values Rvb_G 1174-0 can result from an initial conversion of an audio sample (time domain) into a sample frame (frequency domain). Similarly, etalon gain values Etl_G 1174-1 can be derived from a conversion of an ideal/reference audio signal sample corresponding to the coefficients Etl_AR 1172.

In the embodiment shown, B coefficients 1170-0 can be generated by multiplying generated coefficients Rvb_AR 117-0 by an etalon gain 1174-1. A coefficients 1170-1 can be generated by multiplying etalon components Etl_AR 1172 by a gain corresponding to the generated coefficients (1169). Resulting A and B coefficients can be stored for use as current coefficients 1130.

In some embodiments, as sample frames are received (from FFT conversions of audio samples) calculations as described in FIG. 11-0 (e.g., normalization, smoothing, linear regression, multiplication) can be periodically executed to generate A and B coefficients, which can be applied to sample frames as DR filters. In some embodiments, such calculations can be divided over time, for example, over the time required to convert multiple audio samples into sample frames. Such a division of calculations can advantageously reduce a peak number of processing cycles for a system executing a de-reverberation operation.

FIG. 11-1 shows how, after a set of A and B coefficients has been calculated (1130-0, Filter 2) it can be saved as a previous set of coefficients 1130-1 (Filter 1). Sample frames can be processed for de-reverberation with a combination of such filter values (Filter 2 and Filter 1).

In this way, AC values can be normalized and smoothed before being used to calculate de-reverberation filter values. Calculated de-reverberation filter values can be saved for use with subsequent calculated de-reverberation filter values for application to a sample frame.

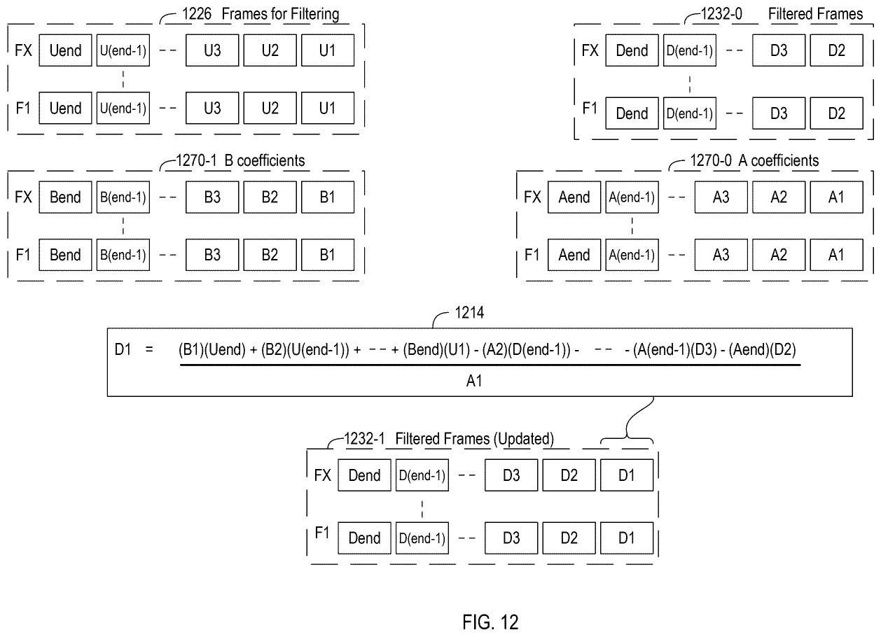

FIG. 12 is a diagram showing an application of filter values according to an embodiment. FIG. 12 shows sample frames for filtering 1226, filtered frames 1232-0, “B” filter coefficients 1270-1 and “A filter coefficients 1270-0. Frames for filtering 1226 can be an array of sample frames as described herein and equivalents. Each sample frame in array 1226 can correspond to a conversion of an audio samples into the frequency domain, and can be composed of components (e.g., magnitudes) for frequencies from F1 to FX. Sample frames in array 1226 can have a chronological order from U1 to Uend, with U1 being a most recent sample frame.

Filtered frames 1232-0 can be an array of filtered frames (i.e., sample frames to which DR filtering has been applied), and so can be composed of (filtered) components for frequencies from F1 to FX. Filtered frames in array 1232-0 can have a same chronological order as array 1226, but can go from D2 to Dend, as there is no frame D1 because frame U1 has not been filtered.

A and B coefficients (1270-0/1) can be coefficients generated with AC values and etalon values. In some embodiments, A and B coefficients (1270-0/1) can be generated as shown in FIG. 11-0.

FIG. 12 shows one example of a calculation 1214 for generating a frequency component (D1) for a filtered frame. A calculation 1214 can correspond to the linear prediction relationship:

$$a ( 1 ) y ( n ) = b ( 1 ) \times ( n ) + b ( 2 ) \times ( n - 1 ) + … + b ( {n}_{b} + 1 ) \times ( n - {n}_{b} ) - a ( 2 ) y ( n - 1 ) - … - a ( {n}_{a} + 1 ) y ( n - {n}_{a} ) .$$

After performing the operation 1214 on all frequency components (F1 to Fx), an array of filtered frames can be updated 1232-1 to include the newly filtered frame D1.

In this way, an array of sample frames to be filtered, including a current sample frame to be filtered, and an array of previously filtered frames can be used to filter the current frame.

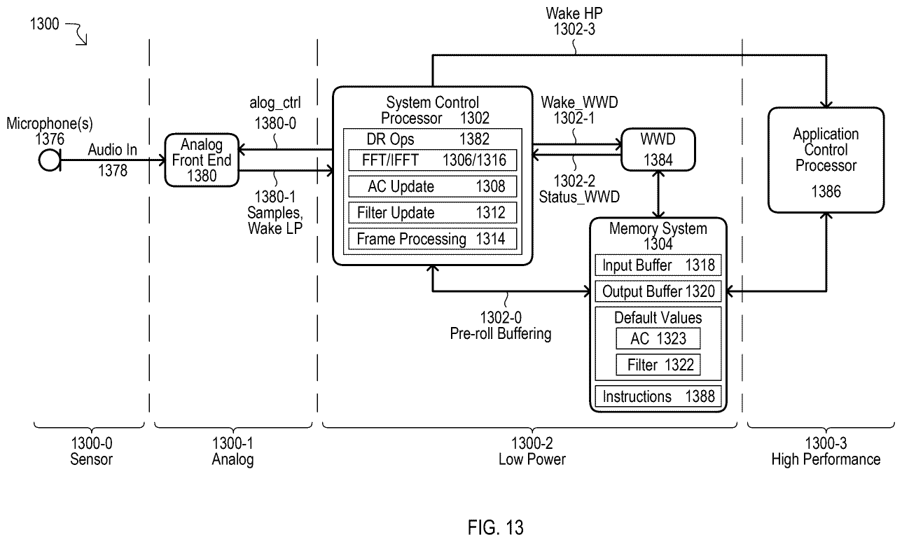

FIG. 13 is a block diagram of a system 1300 according to another embodiment. A system 1300 can include a sensor section 1300-0, an analog section 1300-1, a low power (LP) section 1300-2 and a high performance section 1300-3. A sensor section 1300-0 can acquire audio signals, including speech, and can include one or more microphones 1376 that can provide an audio in signal 1378. In some embodiments, an audio in signal 1378 can be an analog signal.

An analog section 1300-1 can include analog circuits for generating audio samples for de-reverberation filtering and other processing. An analog section 1300-1 can be controlled with analog control signals 1380-0 (alog_ctrl) and can include analog front end (AFE) circuits 1380. AFE circuits 1380 can provide a number of output signals 1380-1 and data for low power section 1300-2, including LP wake signals (Wake LP) and sample frame data.

A low power section 1300-2 can include system control circuits 1302, a memory system 1304, and a wake word detect (WWD) section 1384. System control circuits 1302 can include DR operations 1382 for filtering sample frames as described herein or equivalents. DR operations 1382 can include transform functions 1306/1316, AC update operations 1308, filter update operations 1312 and frame processing operations 1314. Transform functions 1306/1316 can include including FFT type operations and IFFT type operations. AC update operations 1308 can generate AC values that are continually updated as new sample frames are received for processing. Filter update operations 1312 and periodically update DR filter values based on accumulated AC values. Frame processing operations 1314 can apply DR filters to received sample frames, as DR filter values are continuously updated. System control circuits 1302 can generate wake signals for high performance circuits (Wake HP) 1302-3.

In some embodiments, a low power section 1300-1 can be “virtually” always on, having the ability to rapidly transition from an inactive to active state and/or can periodically transition from an inactive to active state. System control circuits 1302 can include any suitable circuits for executing DR operations as described herein, including but not limited to, one or more processing circuits, including instructions, custom logic, programmable logic, and combinations thereof. In some embodiments, system control circuits 1302 can include a reduced instruction set computer (RISC), such as Cortex-M33 processor by ARM, Ltd., as but one example.

A memory system 1304 can include an input buffer 1318, output buffer 1320, and can store default AC values 1323, default DR filter values 1322, and instructions 1388. An input buffer 1318 can receive sample frames from AFE circuit 1380, and in the embodiment shown, such values can be subject to pre-roll buffering 1302-0. Pre-roll buffering 1302-0 can include starting to buffer audio signals sample before processing has started. Output buffer 1320 can store filtered audio samples. Filtered audio samples can be generated by converting filtered frames back to time domain values (i.e., IFFT), and can represent de-reverberated audio signals. Instructions 1388 can be executable by processor circuits of system control circuits 1302 to provide various functions, including DR operations 1382. A memory system 1304 can include any suitable memory circuits, including volatile memory, nonvolatile memory and combinations thereof.

A WWD section 1384 can execute wake-word functions. A WWD section 1384 can receive a wake control indication (Wake_WWD) from system control circuits 1302 and provide status data (Status_WWD) 1302-2 to system control circuits 1302. In some embodiments, WWD section 1384 can access output buffer 1320, and analyze the DR filtered audio data for any wake words, and if any such wake words have been detected, generate or change status data 1032-2.

A high performance section 1300-3 can include application control circuits 1386, which can provide one or more functions in response to de-reverberated audio data (e.g., speech) stored in output buffer 1320 and/or starting functions in response to a detection of a wake word by WWD section 1384. Application control circuits 1386 can include any suitable circuits, including but not limited to, one or more processing circuits, including instructions, custom logic, programmable logic, and combinations thereof. In some embodiments, application control circuits 1386 can have greater computing power or resources than system control circuits 1302, and can include a RISC type processor with neural network processing, such as Cortex-M55 and embedded Ethos-U55 machine learning processor by ARM, Ltd., as but one example.

In this way, a system can include an always on section to detect audio signals, and a low power section to process such audio signals by continuously updating autocorrelation of sample frames, and updating de-reverberation filters with such autocorrelation data.

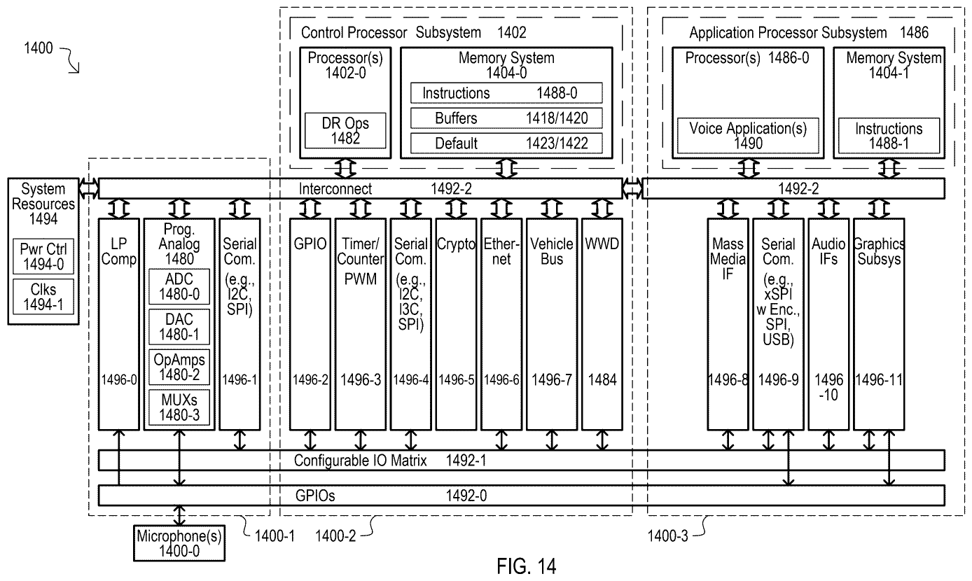

While embodiments can include systems composed of separate components, some embodiments can take the form of a single integrated circuit device. FIG. 14 shows an example of one such embodiment. A system 1400 can be a microcontroller system-on-chip (SoC) type device, and can include sections like those corresponding to FIG. 13, including a sensor section 1400-0, an analog section 1400-1, low power section 1400-2, and a high performance section 1400-3. Such various sections 1400-0 to 1400-3 can include a control processor subsystem 1402, an application processor subsystem 1486, system resources 1494 and various circuit blocks, including a programmable analog section 1480, wake word detect section 1484, and various other sections 1496-0 to 1496-11. The various sections of system 1400 can be in communication with, and connected to, general purpose IOs (GPIOs) 1492-0, a configurable IO matrix 1492-1, and interconnect 1492-2.

Control processor subsystem 1402 can include one or more processor circuits 1402-0 in communication with memory system 1404-0 over interconnect 1492-2. Processor circuits 1402-1 can provide functions by executing instructions 1488-0 stored in a memory system 1404-0. Such functions can include, but are not limited to, DR operations 1482 as described herein and equivalents. In addition to instructions 1488-0, memory system 1404-0 can include buffers 1418/1420 (e.g., input and output buffers) as well as default values 1423/1422 (e.g., default AC values and default DR filter values). In some embodiments, default values 1423/1422 can be stored in nonvolatile memory (NVM) circuits.

Application processor subsystem 1486 can include one or more processor circuits 1486-0 in communication with memory system 1404-1 over interconnect 1492-2. Processor circuits 1486-0 can provide functions by executing instructions 1488-1 stored in a memory system 1404-1. Such functions that can include, but are not limited to, voice applications 1490 that can operate in response to, or with, voice data that has been de-reverberated by control processor subsystem 1402 as described herein and equivalents. In some embodiments, a voice application 1490 can be responsive to the detection of a wake word by WWD section 1484 and/or can include ASR.

A sensor section 1400-0 can include one or more microphones that can be connected to programmable analog section 1480 via GPIOs 1492. Programmable analog section 1480 can be connected to GPIOs 1492-0 and be in communication with interconnect 1492-2. Programmable analog section 1480 can include an analog-to-digital converter (ADC) circuit 1480-0, that can convert analog audio signals detected by microphones 1400-0 into digital audio samples. In some embodiments, such digital audio samples can be stored in an input buffer 1418/1420 of memory system 1404-0. A programmable analog section 1480 can include other analog related circuits, including but not limited to a digital-to-analog converter (DAC) circuit 1480-1, operational amplifiers 1480-2, and analog multiplexers and/or switches 1480-3. In some embodiments, according to configuration data, the various circuit blocks of programmable analog section 1480 can be connected to GPIOs 1492, interconnect 1492-2 and each other.

A WWD section 1484 can be connected to configurable IO matrix 1492-1 and interconnect 1492-1. In some embodiments, WWD section 1484 can access filtered audio samples from an output buffer 1420 of memory system 1404-0, and analyze such audio data for one or more wake words. Upon detecting a wake word, WWD section 1484 an generate an indication to processor(s) (e.g., 1402-0 and/or 1486-0). In addition or alternatively, WWD section 1484 can write status data to a memory location and/or register, which can be accessed by a processor(s) (e.g., 1402-0 and/or 1486-0) can read the status data from such a location.

Within analog section 1400-1, other circuit sections can include low power comparator circuits 1496-0 and low power serial communication circuits 1496-1. Serial communication circuits 1496-1 can include any suitable serial communications, including but not limited to I2C and SPI. In some embodiments, serial communication circuits 1496-1 can be always on.

Within low power section 1400-2, other sections can include a GPIO circuit 1496 that can be configured to form various connections between IO matrix 1492-1 and interconnect 1496-2. Timer/counter PWM circuits 1496-3 can control the generation of pulse width modulation signals for system 1400. Serial communication circuits 1496-4 can provide additional serial communications, including but not limited to I2C, I3C and SPI. In some embodiments, serial communication circuits 1496-4 can be placed into a low power state, and awakened as needed. Crypotgraphic circuits 1496-1 and provide encryption and decryption circuits for accelerating such operations. Ethernet circuits 1496-6 can provide communications capabilities according to IEEE 802.3 and related standards. Vehicle bus circuits 1496-7 can provide communication capabilities compatible with bus standards typically employed in vehicles, including local interconnect network (LIN), controller area network (CAN), and Flexray and related standards.

Within high power section 1400-3, other sections can include mass media interface circuits 1496-8 that can enable communications according to one or more mass media storage standards, including but not limited to SD, SDIO, and eMMC. Serial communication circuits 1496-9 can provide additional communications, including but not limited to xSPI, xSPI with encryption, and USB. Audio IF circuits 1496-10 can enable audio communications according to any suitable standard, including but not limited to I2S, TDM, PDM, and PCM. A graphics subsystem 1496-11 can provide graphics functions according to any suitable standard. In some embodiments, graphics subsystem 1496-11 can provide rendering functions compatible with the Mobile Industry Processor Interface (MIPI) Alliance, including by not limited to DSI and DBI.

System resources 1494 can provide or control various resources of system 1400, and can include power control 1494-0 and timing clocks 1494-1. Power control 1494-0 can control power to the system 1400, including placing circuits and/or inputs into a sleep mode.

In some embodiments, all of system 1400 except sensor section 1400-0 can be formed with a same integrated circuit substrate.

In this way, a single integrated circuit device can include integrated de-reverberation operations that can start processing immediately, with default filter values, and then continuously update filter values based on autocorrelation of frequency components of sampled audio data.

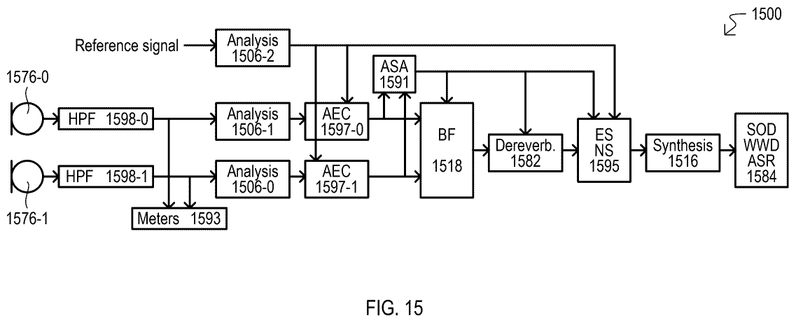

FIG. 15 is a block diagram of another system and method 1500 according to an embodiment. A system 1500 can detect audio data at microphones 1576-0 and 1576-1 and such data can be (high pass) filtered 1598-0 and 1598-1. Results can be metered 1593, and forwarded to analysis 1506-0 and 1506-1. Analysis (1506-0/1) can include transforming signals into the frequency domain (e.g., FFT). In the embodiment shown, a reference signal can be subject to the same analysis 1506-2. Audio data subject to analysis 1506-0/1 can be subject to acoustic echo cancellation (AEC) 1597-0 and 1597-1, which can use analyzed reference signal data. Resulting sample frames processed for AEC can be stored in a buffer 1518 and subject to audio spectrum analysis 1591.

Sample frames stored in buffer 1518 can subject to de-reverberation processing 1582 as described herein and equivalents. Thus, de-reverberation 1582 of system 1500 can start with a first frame and adapt to changing conditions with the generation of continuously updated DR filters.

De-reverberated sample frames can be subject to echo suppression and noise suppression 1595. Resulting processed frames can be subject to a synthesis operation 1516 (e.g., IFFT). Such de-reverberated audio data can then be used for various applications (e.g., automatic speech recognition (ASR), WWD and/or speech overlap detection (SOD) 1584.

A system 1500 can provide online de-reverberation that can provide lower latency, smoother transitions between audio signal parts, and thus increase WWD and ASR quality. Lower latency can be accomplished with the default filter values. WWD and ASR features can be built into a same device (MCU) as processors that execute the de-reverberation filtering. DR calculations can be faster and simpler than conventional approaches, for better performance and/or lower system costs or requirements. Periodically updating DR filters based on accumulated AC values can provide better performance, fewer system errors and/or increased user satisfaction.

In this way, de-reverberation can be included in a system, where the de-reverberation can immediately start DR operations with default DR filters, and then update filters based on historical (e.g., AC) data. Such inclusion can improve audio (e.g., voice) processing system performance.

While the devices and systems described herein have disclosed various methods according to embodiments, additional methods will now be described with reference to flow diagrams.

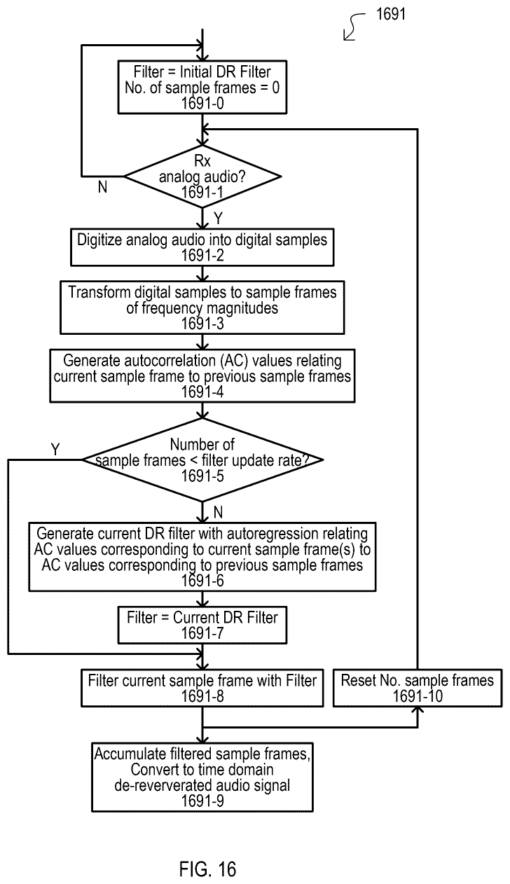

FIG. 16 is a flow diagram of a method 1691 according to an embodiment. A method 1691 can include establishing initial values for processing audio data 1691-0. Such values can include, but are not limited to, setting filter values to initial DR filter value and the number of sample frames to zero. A method 1691 can determine if analog audio data is being received 1692-1. Such an action can include detecting audio signals in any suitable method, including audio signals at sensors exceeding a minimum threshold. If an audio signal is detected (Y from 1691-1), a received audio signal can be digitized into digital samples 1691-2. In some embodiments, such an action can include creating digital samples of relatively small size, including less than 50 ms, less than 25 ms or about 10 ms.

A method 1691 can include transforming digital samples into sample frames of frequency magnitudes 1691-3. Such an action can include any suitable computation, including STFT, that can generate frequency magnitude components over time. In some embodiments, phase values can also be determined. In some embodiments, such an action can result in a rolling set of sample frames, that can include a current (e.g., most recent in time) sample frame, and a number of subsequent sample frames.

A method 1691 can generate AC values that can relate a current sample frame to previous sample frames 1691-4. Such an action can take the form of any of those described herein or equivalents, including autocorrelating frequencies to like frequencies. However, alternate embodiments can include autocorrelation among like and neighboring frequencies.

A method 1691 can include determining if a number of sample frames is less than a filter update rate 1691-5. Such an action can include determining if enough sample frames have been received and processed to generate an updated DR filter. If a filter update rate has not been met (N from 1691-5), a method can filter a current sample frame with a current filter, which can be a default filter 1691-8.

If a filter update rate has been met (Y from 1691-5), a current (i.e., update) filter can be generated 1691-6. A current filter can be generated according to any of the methods described herein, including relating AC values of current sample frame (or frames) to AC values corresponding to previous sample frames. A filter can then be set to the current filter value 1691-7 (i.e., a filter can be updated). A current sample frame can then be filtered (with the updated filter). In some embodiments, filtering a current sample frame with a filter 1691-8 can further include making phase adjustments to the filtered sample frame based on phase values determined in an initial transformation to frequency domain.

A method 1691 can accumulate filtered sample frames, convert them into time domain values to provide a de-reverberated audio signal 1691-9. In some embodiments, such an action can include an ISTFT function.

A method 1691 can further include resetting a number of sample frames 1691-10. Such an action can include resetting a number of sample frames to control when a filter will be updated. In some embodiments, resetting a number of sample frames can include resetting a filter update rate. That is, a rate at which a DR filter can be updated can change over time (e.g., faster at first, slower as speech continues).

In this way, audio samples can be initially filtered with default de-reverberation filters, then with updated de-reverberation filters based on historical audio sample data, such as an autocorrelation of frequency magnitudes.

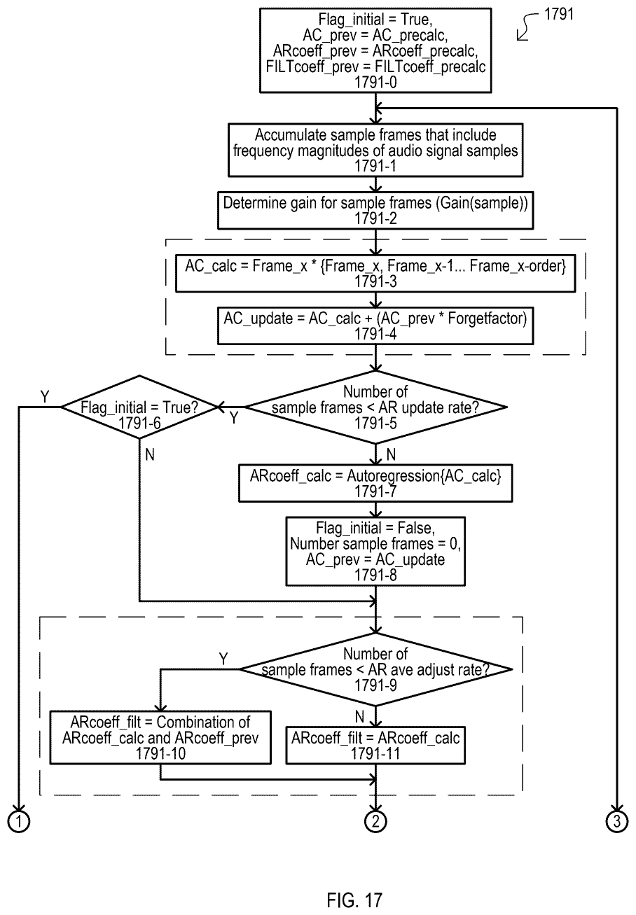

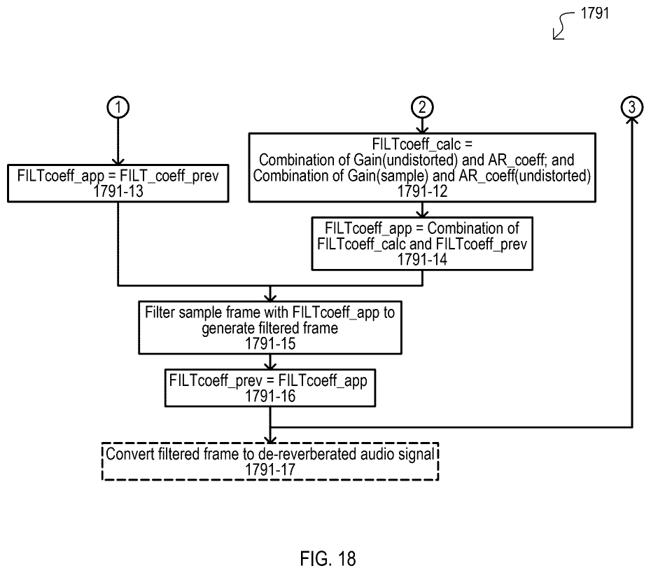

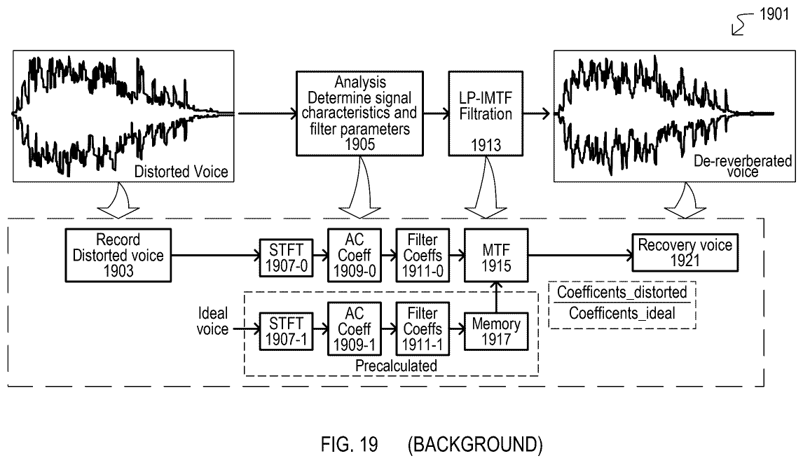

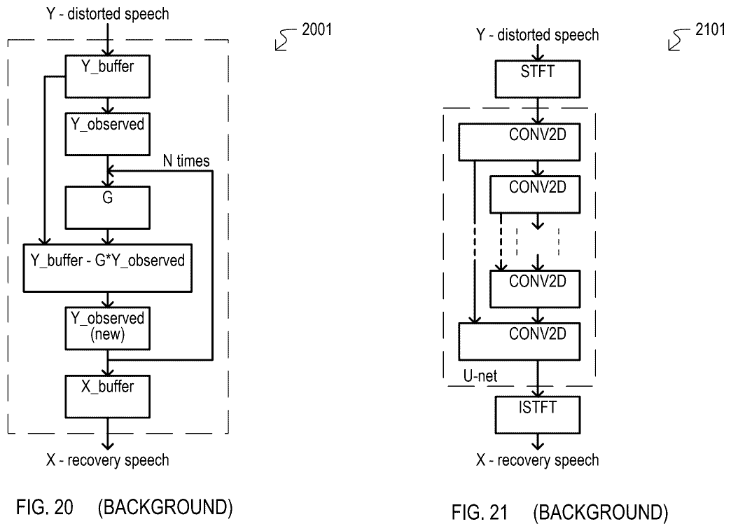

FIGS. 17 and 18 are flow diagrams of a method 1791 according to another embodiment. Connections between FIG. 17-0 and 17-1 are shown by circles numbered 1, 2 and 3. A method 1791 can include setting initial values 1791-0. Such an action can include setting an initial flag (Flag_initial=True), which can indicate a new DR operation has started (i.e., processing of sample frames is starting). Other initial values can include a previous array of AC values (AC_prev), a previous set of AR coefficients (ARcoeff_prev) and a previous set of filter coefficients (FILTcoeff_prev). Such values can be set to pre-calculated values (AC_precalc, ARcoeff_precalc and FILTcoeff_precalc, respectively). Such values can have been generated based on expected speech patterns. In some embodiments, such precalculated values can be updated as more speech is processed.

A method 1791 can include accumulating sample frames that include frequency magnitudes of audio signal samples 1791-1. In some embodiments, such an action can include maintaining an array of unfiltered sample frames. Each sample frame can include values corresponding to frequencies occurring in a time period. A gain for the sample frames can be determined 1791-2. Such a value can be received with the sample frames, and generated with the sample frames.

A method 1791 can calculate an AC value (AC_calc) 1791-3. Such a value can be calculated by multiplying each a value (magnitude) for each frequency of a previous sample frame (Frame_x−1 to Frame_x−order) by a corresponding frequency of a new sample frame (Frame_x). Updated AC values can be calculated by adding current AC values (AC_calc) to previous AC values (AC_prev) as modified by a forget factor. Such an action can take the form of any of those described herein and equivalents.

A method 1791 can determine if a number of sample frames is less than an AR update rate 1791-5. Such an action can trigger an AR update calculation for generating DR filter values. If a number of sample frames is less than an AR update rate (Y from 1791-5), a method 1791 can determine if an initial flag is true 1791-6. If an initial flag is true (Y from 1791-6), not enough sample frames have been received to update filter values, and a method can proceed to FIG. 17-1 (i.e., filter with precalculated values). If an initial flag is not true (N from 1791-6), filter values have been updated, but not enough sample frames have been received for a next filter update, and a method 1791 proceed to a smoothing portion of a method (1791-9).

If a number of sample frames is not less than an AR update rate (N from 1791-5), a method 1791 can calculate new coefficients 1791-7. Such an action can include creating AR coefficients (ARcoeff_calc) with an AR calculation performed on calculated AC values. Such an action can take the form of any of those described herein or equivalents. After generating new AR coefficients, a method 1791 can update values that can determine AR coefficients updated operations 1791-8. In the embodiment shown, such an action can include setting the initial flag to false (Flag_initial=False), a number of sample frames can be reset to zero, and a previous AC value set (AC_prev) can be set to the current AC set (AC_update). As in the case of other embodiments, an update rate (AR update rate) can also be changed at this time. AR coefficients can be used to create the DR filter applied to a sample frame.

In the embodiment shown, AR coefficients can be smoothed when updated based on an AR update rate. When new AR coefficients are first calculated, AR coefficients can be combined with previous AR coefficients (e.g., averaged) to smooth the transition between applied DR filters. In the embodiment shown, if a number of sample frames is less than an AR averaging rate (Y from 1791-9), coefficients for a filter (ARcoeff_filt) can be formed using a combination of newest calculated AR coefficients (ARcoeff_calc) and previous AR coefficients (ARcoeff_prev) 1791-10. If a number of sample frames is greater than or equal to an AR averaging rate (N from 1791-9), coefficients for a filter (ARcoeff_filt) can be the newest calculated AR coefficients (ARcoeff_calc) 1791-11.

Referring now to FIG. 18, if a number of sample frames is less than an AR update rate and an initial flag is true (path from circled 1), an applied filter value (FILTcoeff_app) can be selected that include previous filter values 1791-13, which can be precalculated filter values (as AR values have not yet been updated). If AR values have been updated (path from circled 2), filter values can be calculated (FILTcoeff_calc) 1791-12. Such filter values can include a combination (e.g., product) of an undistorted (e.g., etalon) gain value and currently calculated AR coefficients. Such filter values can further include a combination of a sample gain value and undistorted (e.g., etalon) AR coefficients. Applied filter coefficients (FILTcoeff_app) can then be generated that are a combination (e.g., an averaging type operation) of the new filter coefficients and previous filter coefficients 1791-14.

A method 1791 can include filtering a sample frame with the applied filter values (FILTcoeff_app) 1791-15. Applied filter coefficients can then be saved as previous filter coefficients 1791-16. A method 1791 can return to accumulating sample frames (path to circled 3). Resulting filtered sample frames can be transformed into de-reverberated audio signals 1791-17. Such an action can include any of those described herein, including but not limited to ISTFT.

In this way, a method can initially apply precalculated DR filters to sample frames representing the spectral distribution of audio samples. As sample frames are accumulated, AC values can be generated for frequency magnitudes of sample frames and subject to a forgetting factor. An autoregression calculation can be used to derive initial filter coefficients from the AC values. The application of DR filter values to sample frames can be smoothed by an operation (e.g., averaging) that combines newly calculated filter coefficients with previous filter coefficients.

FIG. 18 is a table showing experimental results of de-reverberation executed with a processing pipeline of a microcontroller processing device according to an embodiment. FIG. 18 shows WWD processing for speech without de-reverberation processing (Before DVRB) and after de-reverberation (DRVB). Results for a “quiet” environment (Quiet) and results with applied traffic noise (Traffic).

Embodiments can include methods, devices and systems that include, by operation of an integrated circuit (IC) device, receiving and storing digital samples of an input audio signal taken over consecutive time periods, converting each digital sample into a sample frame comprising magnitudes of a plurality of frequencies of the digital sample at different frame sample points, periodically generating AC data sets from different consecutive sample frames, periodically determining new filter coefficients from the AC data sets, filtering an initial set of consecutive sample frames with default filter coefficients, filtering sets of consecutive sample frames that follow the initial set with at least new filter coefficients to generate filtered frames, and converting each filtered frames to a time domain output signal. A time domain output signal can be a de-reverberated version of the input audio signal.

Embodiments can include methods, devices and systems that include memory circuits configured to receive and store digital samples of an input audio signal taken over consecutive time periods, autocorrelation (AC) data sets, default filter coefficients, and updated filter coefficients. Processor circuits can be coupled to the memory circuits and can be configured to convert each digital sample into sample frames comprising magnitudes of a plurality of frequencies at different sample points, periodically generate the AC data sets, each from different consecutive sample frames, periodically determine updated filter coefficients from the AC data sets, filter an initial set of consecutive sample frames with the default filter coefficients, filter sets of consecutive sample frames that follow the initial set with at least the updated filter coefficients to generate filtered frames, and convert filtered frames into a time domain output samples corresponding to a de-reverberated version of the input audio signal.

Embodiments can include methods, devices and systems that can include an integrated circuit (IC) device configured to receive and store digital samples of an input audio signal, convert each digital sample into a sample frame comprising magnitudes of a plurality of frequencies, periodically generate autocorrelation (AC) data sets, each from different consecutive sample frames, periodically determine updated filter coefficients from the AC data sets, filter an initial set of consecutive sample frames with the default filter coefficients, filter sets of consecutive sample frames that follow the initial set with at least the updated filter coefficients to generate filtered frames, and convert filtered frames into a time domain output samples corresponding to a de-reverberated version of the input audio signal. At least one microphone can be configured to generate the input audio signal.

Methods, devices and systems according to embodiments can include periodically generating AC data sets by multiplying the frequency magnitudes of i consecutive sample frames by the corresponding frequency magnitudes of the first sample frame of the i consecutive sample frames, to generate an AC data set comprising an f x (n+1) array, where i is an integer greater than one and f is the number of frequencies in each sample frame.

Methods, devices and systems according to embodiments can include periodically generating the AC data sets by storing an AC data set as a previous AC data set, multiplying the frequency components of a previous AC data set by at least one forgetting factor to generate a modified AC data set, and adding the modified AC data set to a more recent AC data set. A forgetting factor can be less than one.

Methods, devices and systems according to embodiments can include periodically determining new filter coefficients by determining AR coefficients that predict most recent AC frequency components from previous frequency components of the same AC data set.

Methods, devices and systems according to embodiments can include filtering sets of consecutive sample frames that follow the initial set by, after filtering a sample frame, saving the newly determined filter coefficients as previous filter coefficients, and filtering a subsequent sample frame with at least a portion of newly determined filter coefficients and at least a portion of the previous filter coefficients.

Methods, devices and systems according to embodiments can include filtering sets of consecutive sample frames that follow the initial set by filtering k consecutive sample frames with the same filter coefficients, and filtering l subsequent sample frames with newly determined filter coefficients, where k and l are integers, and k is less than or equal to l.

Methods, devices and systems according to embodiments can include filtering sets of consecutive sample frames that follow the initial set by filtering each sample frame with currently determined filter coefficients and previously determined filter coefficients.

Methods, devices and systems according to embodiments can include, by operation of an IC device, determining average filter coefficients from a plurality of the filter coefficients, modifying currently determined filter coefficients with the average filter coefficients to generate first adjusted filter coefficients, modifying previously determined filter coefficients with the average filter coefficients to generate second filter coefficients, and adding the first and second filter coefficients to generate the new filter coefficients.

Methods, devices and systems according to embodiments can include by operation of the IC device, receiving and storing reference coefficient values and reference gain values generated with an autoregression (AR) computation on an undistorted voice sample. Periodically determining new filter coefficients can include generating sample coefficient values and sample gain values with an AR computation on at least one AC data set, generating new first filter coefficients using the sample coefficient values and the reference gain values, and generating new second filter coefficients using the reference coefficient values and the sample gain values. Sets of consecutive sample frames that follow the initial set can be filtered by filtering the consecutive sample frames with at least the new first and new second filter coefficients.

Methods, devices and systems according to embodiments can include processor circuits configured to filter consecutive sample frames that follow the initial set with current filter coefficients determined from a most recently determined AC data set, and previous filter coefficients determined from a previous determined AC data set.

Methods, devices and systems according to embodiments can include processor circuits configured to apply most current updated filter coefficients to a selected sample frame to generate a first initial filtered frame, apply previous updated filter coefficients to the sample frame to generate a second initial filtered frame, adjust the first and second initial filtered frames with an average of the most current updated filter coefficients to generate first and second preliminary filtered frames, and combine at least the first and second preliminary filtered frames to generate a filtered frame corresponding to the selected sample frame.

Methods, devices and systems according to embodiments can include processor circuits configured to adjust most recent filter coefficients with at least an average of the current filter coefficients to generate first preliminary filter coefficients, adjust previous filter coefficients with at least an average of the current filter coefficients to generate second preliminary filter coefficients, combine at least the first and second preliminary filter coefficients to generate applied filter coefficients, and apply the applied filter coefficients to a selected sample frame to generate a filtered frame corresponding to the selected sample frame.

Methods, devices and systems according to embodiments can include memory circuits configured to receive and store reference coefficient values and reference gain values generated with an AR computation on an undistorted voice sample. Processor circuits can be configured to generate sample coefficient values and sample gain values with an AR computation on an AC data set, generate new first filter coefficients using the sample coefficient values and the reference gain values, and generate new second filter coefficients using the reference coefficient values and the sample gain values. Sets of consecutive sample frames that follow the initial set can be filtered with at least the new first and second filter coefficients.

Methods, devices and systems according to embodiments can include analog circuits comprising at least one analog-to-digital converter (ADC) configured to generate the digital samples from the input audio signal. Analog circuits, memory circuits and system processor circuits can be formed in a same IC package.

Methods, devices and systems according to embodiments can include an IC device configured to receive an input audio signal from at least one microphone. By operation of analog-to-digital converter circuits, digital samples can be generated from the input audio signal.

Methods, devices and systems according to embodiments can include an IC device configured to apply determined filter coefficients to frequency magnitudes of a selected sample frame to generate a first initial filtered frame, apply previously determined filter coefficients to magnitudes of the selected sample frame to generate a second initial filtered frame, adjust the first and second preliminary initial filtered frames with an average of at least the determined filter coefficients to generate first and second preliminary filtered frames, and combine at least the first and second preliminary filtered frames to generate the filtered frame corresponding to the selected sample frame.

Methods, devices and systems according to embodiments can include an IC device is configured to adjust current filter coefficients with an average of at least current filter coefficients to generate first preliminary filter coefficients, adjust previously determined filter coefficients with the average of at least the current filter coefficients to generate second preliminary filter coefficients, combine at least the first and second preliminary filter coefficients to generate applied filter coefficients, and apply the applied filter coefficients to a selected sample frame to generate a filtered frame corresponding to the selected sample frame.

Methods, devices and systems according to embodiments can include an IC device configured to receive and store reference coefficient values and reference gain values generated with an AR computation on an undistorted voice sample, generate sample coefficient values and sample gain values with an AR computation on an AC data set, generate new first filter coefficients using the sample coefficient values and the reference gain values, generate new second filter coefficients using the reference coefficient values and the sample gain values, and filter sets of consecutive sample frames that follow the initial set with at least the new first and second filter coefficients.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
by operation of an integrated circuit (IC) device
receiving and storing digital samples of an input audio signal taken over consecutive time periods,
converting each digital sample into a sample frame,
generating autocorrelation (AC) data sets from different consecutive sample frames,
determining new filter coefficients from at least the AC data sets,
filtering an initial set of consecutive sample frames with default filter coefficients,
filtering sets of consecutive sample frames that follow the initial set with at least new filter coefficients to generate filtered frames, and
converting each filtered frames into a time domain output signal; wherein
the time domain output signal comprises a de-reverberated version of the input audio signal.

2. The method of claim 1, wherein:
each sample frame comprises magnitudes of a plurality of frequencies of the corresponding digital sample at different frame sample points; and
generating AC data sets comprises
multiplying the frequency magnitudes of i consecutive sample frames by the corresponding frequency magnitudes of a first sample frame of the i consecutive sample frames to generate an AC data set comprising an f x (n+1) array, where i is an integer greater than one and f is the number of frequencies in each sample frame.

3. The method of claim 1, wherein
generating the AC data sets comprises
storing an AC data set as a previous AC data set,
multiplying frequency components of a previous AC data set by at least one forgetting factor to generate a modified AC data set, and
adding the modified AC data set to a more recent AC data set; wherein
the at least one forgetting factor is less than one.

4. The method of claim 1, wherein:
determining new filter coefficients comprises determining autoregression (AR) coefficients that predict most recent AC frequency components from previous frequency components of the same AC data set.

5. The method of claim 1, wherein:
determining new filter coefficients includes
determining first new filter coefficients from at least one AC data set, and
determining second new filter coefficients from at least another AC data set generated after the one AC data set; and
filtering sets of consecutive sample frames that follow the initial set includes
filtering a sample frame with at least the first new filter coefficients, and
filtering a subsequent sample frame with at least a portion of the first new filter coefficients and at least a portion of the second new filter coefficients.

6. The method of claim 1, wherein:
determining the new filter coefficients includes
determining first new filter coefficients from at least one AC data set and
determining second new filter coefficients from at least another AC data set generated after the one AC data set; and
filtering sets of consecutive sample frames that follow the initial set includes
filtering k consecutive sample frames with the first new filter coefficients, and
filtering l subsequent sample frames with the second new filter coefficients, where k and l are integers, and k is less than or equal to l.

7. The method of claim 1, wherein:
determining new filter coefficients includes determining a sequence of new filter coefficient sets over time; and
filtering sets of consecutive sample frames that follow the initial set includes filtering each sample frame with at least one new filter coefficient set and a previous new filter coefficient set of the sequence.

8. The method of claim 1, further including:
by operation of the IC device,
determining group filter coefficients from a plurality of the filter coefficients,
modifying determined filter coefficients with the group filter coefficients to generate first adjusted filter coefficients,
modifying previously determined filter coefficients with the group filter coefficients to generate second filter coefficients, and
adding the first and second filter coefficients to generate the new filter coefficients.

9. The method of claim 1, further including:
by operation of the IC device,
receiving and storing reference coefficient values and reference gain values generated with an autoregression (AR) computation on an undistorted voice sample;
wherein periodically determining new filter coefficients includes
generating sample coefficient values and sample gain values using an AR computation on at least one AC data set,
generating new first filter coefficients using the sample coefficient values and the reference gain values, and
generating new second filter coefficients using the reference coefficient values and the sample gain values; and
wherein the filtering sets of consecutive sample frames that follow the initial set includes filtering the consecutive sample frames with at least the new first and new second filter coefficients.

10. A device, comprising:
memory circuits configured to
receive and store digital samples of an input audio signal taken over consecutive time periods, autocorrelation (AC) data sets, default filter coefficients, and updated filter coefficients;
processor circuits coupled to the memory circuits and configured to
convert each digital sample into sample frames,
generate the AC data sets, each from different consecutive sample frames,
determine updated filter coefficients from at least the AC data sets,
filter an initial set of consecutive sample frames with the default filter coefficients,
filter sets of consecutive sample frames that follow the initial set with at least the updated filter coefficients to generate filtered frames, and
convert filtered frames into a time domain output samples corresponding to a de-reverberated version of the input audio signal.

11. The device of claim 10, wherein:
the processor circuits are configured to filter consecutive sample frames that follow the initial set with
current filter coefficients determined with one of the generated AC data sets, and
previous filter coefficients determined with an AC data set generated prior to the one of the generated AC data sets.

12. The device of claim 10, wherein:
the processor circuits are configured to
determine sets of updated filter coefficients over time from at least the AC data sets,
apply one set of updated filter coefficients to a selected sample frame to generate a first initial filtered frame,
apply a set of updated filter coefficients determined prior to the one set of updated filter coefficients to the sample frame to generate a second initial filtered frame,
adjust the first and second initial filtered frames with a function of the one set of updated filter coefficients to generate first and second preliminary filtered frames, and
combine at least the first and second preliminary filtered frames to generate a filtered frame corresponding to the selected sample frame.

13. The device of claim 10, wherein:
the processor circuits are configured to
determine sets of updated filter coefficients over time from at least the AC data sets,
adjust one set of updated filter coefficients with at least a group value representing another set of filter coefficients to generate first preliminary filter coefficients,
adjust a set of updated filter coefficients determined prior to the one set of filter coefficients with the group value to generate second preliminary filter coefficients,
combine at least the first and second preliminary filter coefficients to generate applied filter coefficients, and
apply the applied filter coefficients to a selected sample frame to generate a filtered frame corresponding to the selected sample frame.

14. The device of claim 10, wherein:
the memory circuits are further configured to receive and store reference coefficient values and reference gain values generated with an autoregression (AR) computation on an undistorted voice sample; and
processor circuits are configured to
generate sample coefficient values and sample gain values with an AR computation on an AC data set,
determine first-type updated filter coefficients using the sample coefficient values and the reference gain values, and
determine second-type filter coefficients using the reference coefficient values and the sample gain values; and
filter sets of consecutive sample frames that follow the initial set with at least the first-type and second-type filter coefficients.

15. The device of claim 10, further including:
analog circuits comprising at least one analog-to-digital converter (ADC) configured to generate the digital samples from the input audio signal; wherein
the analog circuits, memory circuits and system processor circuits are formed in a same integrated circuit (IC) package.

16. A system, comprising:
an integrated circuit (IC) device configured to
receive and store digital samples of an input audio signal,
convert each digital sample into a sample frame,
generate autocorrelation (AC) data sets, each from different consecutive sample frames,
determine updated filter coefficients from at least the AC data sets,
filter an initial set of consecutive sample frames with default filter coefficients,
filter sets of consecutive sample frames that follow the initial set with at least the updated filter coefficients to generate filtered frames, and
convert filtered frames into a time domain output samples corresponding to a de-reverberated version of the input audio signal; and
at least one microphone configured to generate the input audio signal.

17. The system of claim 16, wherein:
the IC device is further configured to
receive the input audio signal from the at least one microphone, and
by operation of analog-to-digital converter circuits, generate the digital samples from the input audio signal.

18. The system of claim 16, wherein:
the IC device is configured to
apply determined updated filter coefficients to a selected sample frame to generate a first initial filtered frame,
apply previously determined updated filter coefficients to the selected sample frame to generate a second initial filtered frame,
adjust the first and second preliminary initial filtered frames with a group value representative of at least the determined updated filter coefficients to generate first and second preliminary filtered frames, and
combine at least the first and second preliminary filtered frames to generate the filtered frame corresponding to the selected sample frame.

19. The system of claim 16, wherein:
the IC device is configured to
generate sets of updated filter coefficients,
adjust one set of updated filter coefficients with a group value representing at least another set of filter coefficients to generate first preliminary filter coefficients,
adjust a set of updated filter coefficients determined prior to the one set of updated filter coefficients with the group value to generate second preliminary filter coefficients,
combine at least the first and second preliminary filter coefficients to generate applied filter coefficients, and
apply the applied filter coefficients to a selected sample frame to generate a filtered frame corresponding to the selected sample frame.

20. The system of claim 16, wherein:
the IC device is further configured to
receive and store reference coefficient values and reference gain values generated with an autoregression (AR) computation on an undistorted voice sample,
generate sample coefficient values and sample gain values with an AR computation on an AC data set,
generate first-type filter coefficients using the sample coefficient values and the reference gain values,
generate second-type filter coefficients using the reference coefficient values and the sample gain values, and
filter sets of consecutive sample frames that follow the initial set with at least the first-type and second-type filter coefficients.
